(19) United States
(12) Patent Application Publication
(10) Pub. No.: US 2004/0252909 A1
(43) Pub. Date: Dec. 16, 2004

(54) Image processing method, image processing apparatus, program, and computer storage medium

(75) Inventors: Hiroyuki Shinbata, Tochigi (JP); Naoto Takahashi, Tochigi (JP)

Correspondence Address: Canon U.S.A. Inc., Intellectual Property Department, 15975 Alton Parkway, Irvine, CA, 92618-3731, US

(73) Assignee: Canon Kabushiki Kaisha, Tokyo (JP)

(21) Appl. No.: 10/835,606

(22) Filed: Apr. 28, 2004

(30) Foreign Application Priority Data
Jun. 11, 2003 (JP) 2003/166522

(51) Int. Cl. G06K 9/00; G06K 9/36

(52) U.S. Cl. 382/260; 382/132; 382/240

(57) ABSTRACT

An image processing apparatus includes: a frequency-component resolution unit, a frequency-component conversion unit, a restoring unit, and an adjustment unit. The frequency-component resolution unit converts an original image into frequency coefficients, where each of the frequency coefficients corresponds to a predetermined one of a plurality of frequency bands. The frequency-component conversion unit converts the calculated frequency coefficients according to frequency-coefficient conversion curves, where each of the frequency-coefficient conversion curves corresponds to a predetermined one of the plurality of frequency bands. The restoring unit performs inverse conversion for the converted frequency coefficients. The adjustment unit adjusts a pixel-value range (having a predetermined value) of a restored image obtained through the inverse conversion.

### BACKGROUND OF THE INVENTION

1. Field of the Invention

The present invention relates to an image processing apparatus and a method for performing frequency processing for each of a plurality of frequency bands, and particularly relates to an image processing apparatus and a method for changing frequency coefficients, where each of the frequency coefficients corresponds to a predetermined one of the frequency bands, and adjusting a pixel-value range.

2. Description of the Related Art

Recently, as digital technology progresses, it has become possible to convert an X-ray image into digital image signals and perform image processing, such as frequency processing, for the digital image signals and gray-scale conversion for the processed digital image signals. Then, the digital image signals are displayed on a Cathode Ray Tube (CRT) or the like, as an image, or output to a printer, as an image on a film.

U.S. Pat. No. 5,805,721 discloses a method for performing frequency processing by resolving an image into a plurality of frequency bands and changing and restoring image components, where each of the image components corresponds to a predetermined one of the plurality of frequency bands.

However, known frequency processing methods have no technical ideas of adjusting the pixel-value range of an image that was subjected to the frequency processing. Usually, an image that was subjected to frequency processing has an increased pixel-value range. For example, where an image that was subjected to processing such as gray-scale conversion is displayed on a display medium, part of an object is often not displayed. In particular, where the frequency processing is performed for a low-frequency component, the difference between the pixel-value range of an original image and that of an image obtained through the frequency processing becomes significant.

Dynamic-range compression processing has often been used for obtaining an image suitable for CRT display and/or film output.

Japanese Patent No. 2663189 discloses a dynamic-range compression method shown by the following equations:

SD=Sorg+f(SUS) (2),

and

SUS=ΣSorg/M2 (3),

wherein SD indicates a pixel value of an image after frequency processing, Sorg indicates a pixel value of an original image (pixel value of an input image), SUS indicates an average pixel value obtained by taking a moving average of the original image (input image), where the mask size is M*M, and f(X) indicates a monotonously decreasing function. According to this method, the density value (pixel value) of pixels of a low-frequency image is compressed, where the density value is less than Dth (threshold of pixel value).

Hitherto, known dynamic-range adjustment methods merely disclosed technical ideas of adjusting a dynamic range. However, the known dynamic-range adjustment methods disclose no technical ideas of obtaining a frequency-processing effect by changing a frequency-component ratio of a pixel range in a changed dynamic range. Therefore, the frequency-component ratio of the pixel range in the changed dynamic range could not be adjusted. Further, the known dynamic-range adjustment methods are substantially the same as a method for performing gray-scale conversion for low-frequency components. That is to say, these methods disclose no technical ideas of adjusting high-frequency components. Subsequently, high-frequency components could no be adjusted by known dynamic-range compression methods.

### SUMMARY OF THE INVENTION

Accordingly, an image processing apparatus and a method for changing frequency coefficients are provided. Each of the frequency coefficients corresponds to a predetermined one of a plurality of frequency bands, and adjusting a pixel-value range, for example.

According to an aspect of the present invention, an image processing apparatus comprises a frequency-component resolution unit for converting an original image into frequency coefficients. Each of the frequency coefficients corresponds to a predetermined one of a plurality of frequency bands. The image processing apparatus further comprises a frequency-component conversion unit for converting the frequency coefficients calculated by the frequency-component resolution unit by using frequency-coefficient conversion curves, where each of the frequency-coefficient conversion curves corresponds to a predetermined one of the plurality of frequency bands. The image processing apparatus further comprises a restoring unit for performing inverse conversion for the frequency coefficients converted by the frequency-component conversion unit and an adjustment unit for adjusting a pixel-value range of a processed image obtained through the inverse conversion. The pixel-value range has a predetermined value.

In accordance with an aspect of the present invention, the adjustment unit adjusts the pixel-value range of the processed image based on a pixel-value range of the original image.

In accordance with another aspect of the present invention, the frequency-component conversion unit changes a conversion rate of the frequency coefficients based on a change rate of the pixel-value adjusted by the adjustment unit.

In accordance with another aspect of the present invention, the frequency-component conversion unit converts the frequency coefficients according to pixel values of the original image, each of the pixel values corresponding to a predetermined one of the frequency coefficients and a predetermined one of the frequency-coefficient conversion curves.

In accordance with another aspect of the present invention, the frequency-component conversion unit converts the frequency coefficients with reference to an object to be photographed according to the frequency-coefficient conversion curves.

In accordance with another aspect of the present invention, the frequency-component conversion unit converts the frequency coefficients according to density values, each of the density values corresponding to a predetermined one of the frequency coefficients, and a predetermined one of the frequency-coefficient curves.

According to yet another aspect of the present invention, the frequency-component resolution unit converts an image into coefficients using wavelet conversion.

According to yet another aspect of the present invention, the frequency-component resolution unit converts an image into coefficients using Laplacian conversion.

According to still another aspect of the present invention, the image processing apparatus further comprises an X-ray emission unit that emits an X-Ray, a two-dimensional X-ray sensor that converts the X-ray into image data and an image generator that generates the original image based on the image data.

According to another aspect of the present invention, an image processing apparatus comprises a gray-scale conversion unit for performing gray-scale conversion for an original image according to gray-scale conversion curves and a frequency-component resolution unit for converting the original image into frequency coefficients, where each of the frequency coefficients corresponds to a predetermined one of a plurality of frequency bands. The image processing apparatus further comprises a frequency-component conversion unit for changing the frequency coefficients calculated by the frequency-component resolution unit, based on inclinations of the gray-scale conversion curves, and converting the changed frequency coefficients according to frequency-coefficient conversion curves. Each of the frequency conversion curves corresponds to a predetermined one of the plurality of frequency bands. The image processing apparatus further comprises a restoring unit for performing inverse conversion for the frequency coefficients converted by the frequency-component conversion unit in order to compose a processed image.

According to another aspect of the present invention, an image processing method is provided. This method comprises converting an original image into frequency coefficients. Each of the frequency coefficients corresponds to a predetermined one of a plurality of frequency bands. The image processing method further comprises converting the frequency coefficients according to frequency-coefficient conversion curves. Each of the frequency-coefficient conversion curves corresponds to a predetermined one of the plurality of frequency bands. The image processing method further comprises performing inverse conversion for the frequency coefficients converted at the frequency-component conversion step and adjusting a pixel-value range of a restored image obtained through the inverse conversion. The pixel-value range has a predetermined value.

According to another aspect of the present invention, an image processing method is provided. This method comprises performing gray-scale conversion for an original image according to gray-scale conversion curves and a converting the original image into frequency coefficients. Each of the frequency coefficients corresponds to a predetermined one of a plurality of frequency bands. The image processing method further comprises changing the frequency coefficients calculated based on inclinations of the gray-scale conversion curves, and converting the frequency coefficients calculated according to frequency-coefficient conversion curves. Each of the frequency conversion curves corresponds to a predetermined one of the plurality of frequency bands. The image processing method further comprises performing inverse conversion for the frequency coefficients converted at the frequency-component conversion step.

Further features and advantages of the present invention will become apparent from the following description of the preferred embodiments (with reference to the attached drawings).

### BRIEF DESCRIPTION OF THE DRAWINGS

The accompanying drawings, which are incorporated in and constitute a part of the specification, illustrate embodiments of the invention and, together with the descriptions, serve to explain the principle of the invention.

FIG. 1 is a block diagram of an image processing apparatus according to a first embodiment of the present invention.

FIG. 2 is a flowchart illustrating processing procedures performed by the image processing apparatus shown in FIG. 1.

FIG. 3 shows an example operation panel.

FIG. 4A illustrates discrete wavelet conversion.

FIG. 4B also illustrates the discrete wavelet conversion.

FIG. 4C illustrates inverse discrete wavelet conversion.

FIG. 5 illustrates example frequency conversion curves.

FIG. 6 illustrates an example response characteristic.

FIG. 7 is a flowchart illustrating processing procedures performed by an adjustment circuit.

FIG. 8 illustrates example pixel-value ranges.

FIG. 9 illustrates an example coefficient-conversion rate changing according to a pixel value.

FIG. 10 illustrates example response characteristics, where each of the response characteristics corresponds to a predetermined pixel value.

FIG. 11 is a block diagram of an image processing apparatus according to a third embodiment of the present invention.

FIG. 12 illustrates an example gray-scale conversion curve.

FIG. 13 is a flowchart illustrating processing procedures performed by an image processing apparatus according to a fourth embodiment of the present invention.

FIG. 14 illustrates an example curve for changing a dynamic range.

FIG. 15 is a flowchart illustrating processing procedures performed by an image processing apparatus according to a fifth embodiment of the present invention.

### DESCRIPTION OF THE PREFERRED EMBODIMENTS

First Embodiment

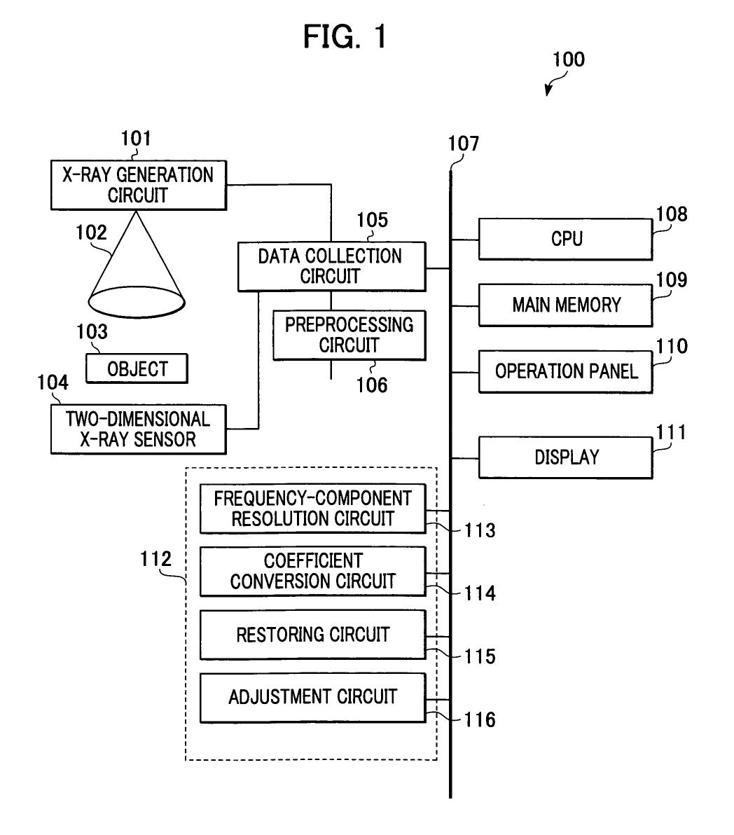

FIG. 1 illustrates an X-ray imaging apparatus 100 according to a first embodiment of the present invention. The X-ray imaging apparatus 100 is used for processing a photographed image for every frequency band and includes a preprocessing circuit 106, a central processing unit (CPU) 108, a main memory 109, an operation panel 110, an image display 111, an image processing circuit 112, and a CPU bus 107 for transmitting and receiving data therethrough.

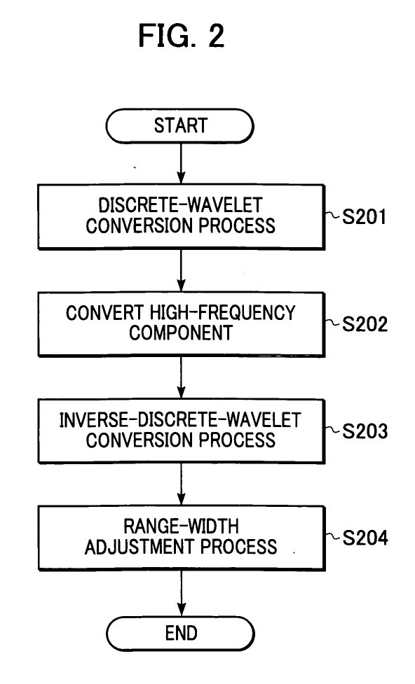

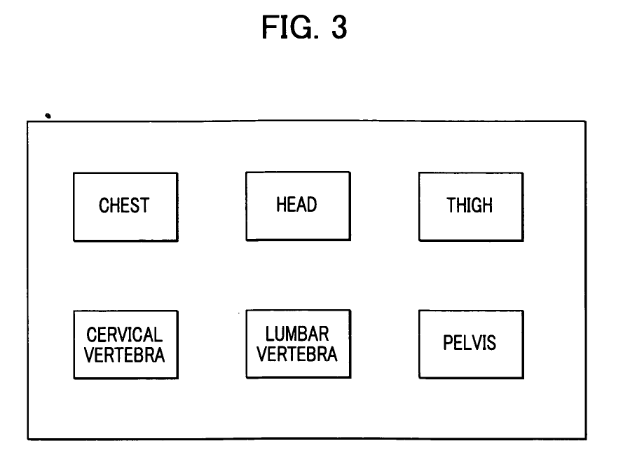

The X-ray imaging apparatus 100 further includes a data collection circuit 105 connected to the preprocessing circuit 106, and a two-dimensional X-ray sensor 104 and an X-ray generation circuit 101 that are connected to the data collection circuit 105. These circuits are also connected to the CPU bus 107. FIG. 2 is a flowchart illustrating the flow of processing procedures performed by the X-ray imaging apparatus 100. FIG. 3 illustrates an example of the operation panel 110. An operator designates one of buttons corresponding to a predetermined part of a human body, so as to photograph the designated part in a manner suitable therefor.

In the above-described X-ray imaging apparatus 100, the main memory 109 stores various types of data required for processing performed by the CPU 108. This main memory 109 has at least one work memory for the CPU 108.

The CPU 108 has operation control over the entire apparatus by using the memory 109 according to an instruction transmitted from the operation panel 110. The X-ray imaging apparatus 100 operates, as described below.

First, the X-ray generation circuit 101 emits an X-ray beam 102 to an object 103.

The X-ray beam 102 emitted from the X-ray generation circuit 101 passes through the object 103 and is attenuated. Then, the X-ray beam 102 reaches the two-dimensional X-ray sensor 104 and is output therefrom, as an X-ray image. In this embodiment, this X-ray image is a human-body image, for example.

The data collection circuit 105 converts the X-ray image output from the two-dimensional X-ray sensor 104 into electrical signals and supplies them to the preprocessing circuit 106. The preprocessing circuit 106 performs offset correction process, gain correction process, and so forth, for the signals (X-ray image signals) transmitted from the data collection circuit 105. These X-ray image signals processed by the preprocessing circuit 106 are transferred to the main memory 109 and the image processing circuit 112 via the CPU bus 107 under the control of the CPU 108, as an original image.

As shown in FIG. 1, the image processing circuit 112 includes a frequency-component resolution circuit 113 for performing discrete wavelet conversion (hereinafter referred to as DWT conversion) for the original image and obtaining a frequency coefficient (wavelet conversion coefficient) for each frequency band. The image processing circuit 112 further includes a coefficient conversion circuit 114 for converting the frequency coefficient obtained by the frequency-component resolution circuit 113, a restoring circuit 115 for performing inverse-discrete wavelet conversion (hereinafter referred to as inverse DWT conversion), based on the frequency coefficient converted by the coefficient conversion circuit 114, and an adjustment circuit 116 for adjusting the pixel-value range of an image restored by the restoring circuit 115.

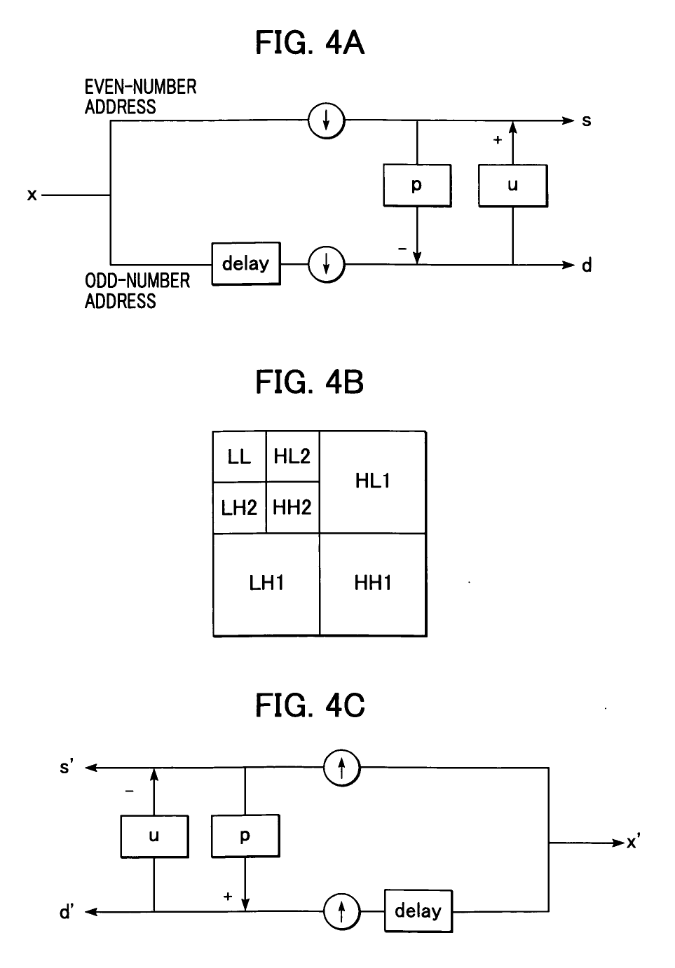

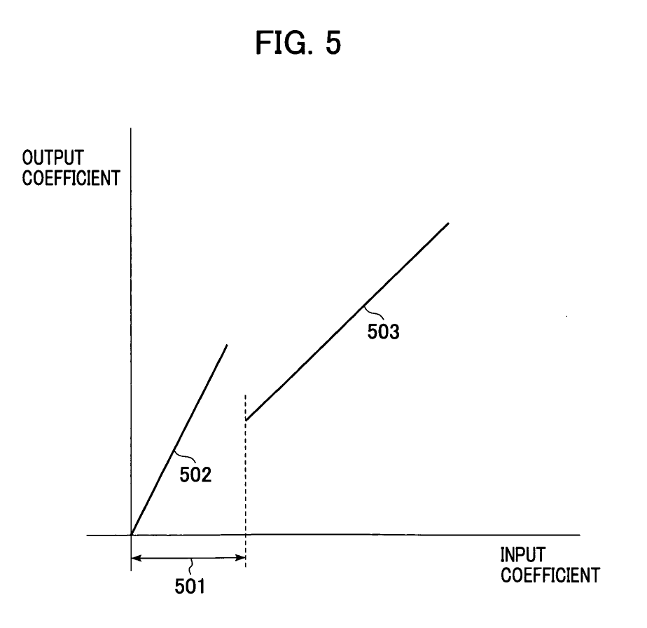

FIG. 4A illustrates the DWT conversion process performed by the frequency-component resolution circuit 113. FIG. 4B illustrates an example group of conversion coefficients on a level of two obtained through two-dimensional DWT conversion process. FIG. 4C illustrates the inverse DWT conversion process performed by the restoring circuit 115. FIG. 5 shows example frequency-coefficient conversion curves on predetermined levels, where the horizontal axis indicates an input coefficient and the vertical axis indicates an output coefficient. A range 501 indicates a coefficient range directly relating to the frequency processing. The other range (below coefficient conversion curve 503) corresponds to edge components or the like. The effect of the frequency processing can be obtained by changing the coefficients in the range 501 according to the coefficient conversion curve 502. Further, an artifact such as an overshoot is prevented from being generated by keeping the inclination value of a coefficient conversion curve 503 at one.

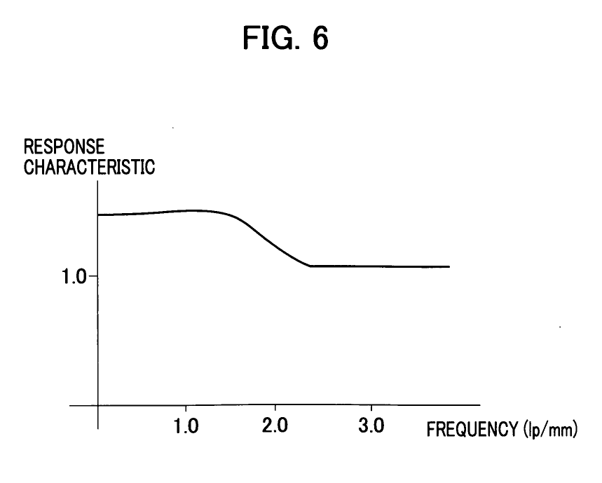

FIG. 6 illustrates the response characteristic of the coefficient conversion performed by the coefficient conversion circuit 114. In FIG. 6, the horizontal axis indicates the frequency value and the vertical axis indicates the response characteristic. In this case, the response characteristic is the ratio between the amplitude of a predetermined frequency of an image before frequency processing and that of a predetermined frequency of an image after the frequency processing. For example, where the response-characteristic value of a frequency of 2.0 (lp/mm) is one and five tenths, it means that the amplitude of the frequency of 2.0 (lp/mm) of the image increases by one and five tenths times through the frequency processing, whereby the sharpness of the image increases.

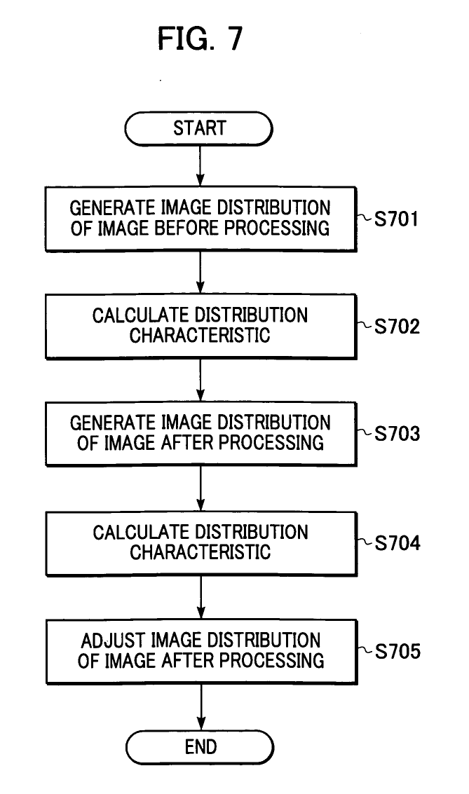

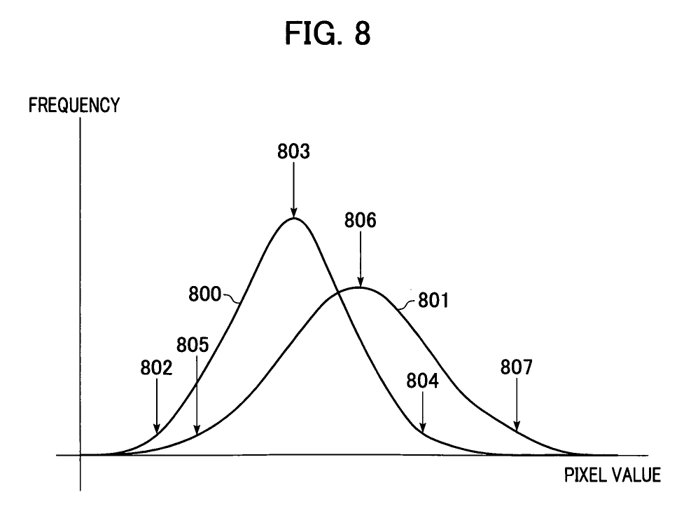

FIG. 7 is a flowchart illustrating the flow of processing procedures performed by the adjustment circuit 116. FIG. 8 illustrates a method for adjusting the pixel-value range by using the adjustment circuit 116, where the horizontal axis indicates the pixel value and the vertical axis indicates the occurrence frequency of the pixel value. Further, reference numeral 800 indicates the pixel-value distribution of the image before the frequency processing is performed and reference numeral 801 indicates the pixel-value distribution of a restored (processed) image. Reference numerals 802, 803, and 804 indicate pixel-value positions corresponding to the bottom 10% position of an accumulation histogram, the peak position of the accumulation histogram, and the top 10% position of the accumulation histogram of the original image, respectively. Reference numerals 805, 806, and 807 indicate pixel-value positions corresponding to the bottom 10% position of an accumulation histogram, the peak position of the accumulation histogram, and the top 10% position of the accumulation histogram of the restored image, respectively.

The response characteristic indicates the ratio between the amplitude of a predetermined frequency of the image before the frequency processing and that of a predetermined frequency of the image after the frequency processing.

The flow of the processing procedures performed in this embodiment will now be described with reference to FIG. 2.

Information about the original image subjected to preprocessing by the preprocessing circuit 106 and a body part designated through the operation panel 110 are transferred to the image processing circuit 112 via the CPU bus 107. In this image processing circuit 112, the frequency-component resolution circuit 113 performs a two-dimensional discrete wavelet conversion process, thereby calculating a frequency coefficient at step S201. Then, the calculated frequency coefficient is output. Image data stored in the main memory 109 is successively read, converted by the frequency-component resolution circuit 113, and written into the main memory 109 again. The image signals input to the frequency-component resolution circuit 113 are separated into an even-number address signal and an odd-number address signal by using a delay element and a down sampler in combination and subjected to filtering by using two filters p and u. In FIG. 4A, s and d indicate a low-pass coefficient and a high-pass coefficient obtained, respectively, where one-level resolution is performed for a one-dimensional image signal. These coefficients are calculated according to the following equations:

d(n)=x(2*n+1)−floor((x(2*n)+x(2*n+2))/2) (1),

and

s(n)=x(2*n)+floor((d(n−1)+d(n))/4) (2),

where x(n) indicates an image signal subjected to the conversion.

Through the above-described processing, one-dimensional DWT conversion processing for the image signals is performed. Two-dimensional DWT conversion is achieved by successively performing the one-dimensional DWT conversion process along the directions of the horizontal and vertical axes of an image. Since the details of the two-dimensional DWT conversion are known, the description thereof is omitted. As shown in FIG. 4B, the image signals are resolved into frequency coefficients of different frequency bands. That is to say, the image signals are resolved into frequency coefficients HH1, HL1, LH1, . . . , and LL (hereinafter referred to as sub-bands). In this drawing, only the frequency components on the level of two are illustrated. However, in this embodiment, the resolution process is performed for frequency components on a level of five or so. Here, the coefficient on each level indicates the typical value of a predetermined frequency band. Therefore, where the coefficient value on each level is changed by the coefficient-conversion circuit 114 and restored by the restoring circuit 115, the value of a coefficient component corresponding to the changed level is changed.

The coefficient conversion circuit 114 converts the frequency coefficient that is resolved and calculated by the frequency-component resolution circuit 113 by selecting and using one of different coefficient conversion curves according to each frequency band (each level). Thus, the frequency-component ratio is changed at step S202. For example, where the conversion ratio of coefficients on levels corresponding to a low-frequency band is increased, so as to be higher than that of coefficients on levels corresponding to a high-frequency band, the ratio of low-frequency components becomes higher than that of high-frequency components, as shown in FIG. 6. In this case, the wave amplitude of low frequencies of the processed image becomes larger than that of high frequencies thereof. As described above, this effect can be obtained by changing the shape of each of coefficient conversion curves on different levels. More specifically, where a predetermined coefficient is converted and the value thereof becomes higher than before, the response characteristic of a frequency band corresponding to the level of the converted coefficient increases. In this embodiment, changing the frequency-component ratio means that the ratio between the amplitude of a predetermined frequency before being subjected to the frequency processing and that of the predetermined frequency after the frequency processing becomes different from the ratio between the amplitude of the other frequencies before being subjected to the frequency processing and that of the other frequencies after the frequency processing.

Each of the coefficient conversion curves corresponds to a predetermined part of a human body. Therefore, a predetermined coefficient conversion curve is selected according to a selected body part. At step S203, the restoring circuit 115 performs the inverse DWT conversion for the coefficients converted by the coefficient conversion circuit 114. The converted frequency coefficients stored in the main memory 109 are successively read and converted by the restoring circuit 115. Then, the converted frequency coefficients are written into the main memory 109 again. FIG. 4C illustrates the inverse DWT conversion process performed by the restoring circuit 115. The frequency coefficients input to the restoring circuit 115 are subjected to a filtering process through two filters u and p. Then, the filtered frequency coefficients are subjected to up-sampling, superimposed on each other, and output, as an image signal x′. This process is shown by the following equations:

x′(2*n)=s′(n)−floor((d′(n−1)+d′(n))/4) (3),

and

x′(2*n+1)=d′(n)+floor((x′(2*n)+x′(2*n+2))/2) (4).

Through the above-described processing, one-dimensional inverse DWT conversion process for the frequency coefficients is performed. Two-dimensional inverse DWT conversion is achieved by successively performing the one-dimensional inverse DWT conversion process along the directions of the horizontal and vertical axes of an image. Since the details of the two-dimensional inverse DWT conversion are known, the description thereof is omitted. Resolution using Laplacian pyramid or the like can be used for calculating a frequency coefficient for each frequency band, as an alternative to the wavelet conversion. However, the wavelet conversion has a fine frequency-separation characteristic and allows for adjusting the frequency-component ratio minutely during the frequency processing. Thus, the frequency processing can be easily controlled.

FIG. 7 illustrates the flow of processing procedures performed by the adjustment circuit 116. The adjustment circuit 116 makes the histogram and accumulation histogram of the entire original image that was stored in the main memory 109 at step S701. Then, the adjustment circuit 116 calculates the peak position 803 of the histogram, and the bottom 10% position 802 and the top 10% position 804 of the accumulation histogram at step S702. Then, the adjustment circuit 116 further makes the histogram and accumulation histogram of the entire restored image at step S703, and calculates the peak position 806 of the histogram, and the bottom 10% position 805 and the top 10% position 807 of the accumulation histogram at step S704. The adjustment circuit 116 converts the gray scale of the restored image so that the peak position 806 agrees with the peak position 803, the pixel-value range 804 agrees with the pixel-value range 802, and the pixel-value range 805 agrees with the pixel-value range 807. More specifically, the adjustment circuit 116 shifts the pixel-value ranges of the restored image, so as to make the above-described peak positions agree with each other. Then, the adjustment circuit 116 adjusts the dynamic range of the entire image. This process can be achieved by using affine conversion.

In this embodiment, the pixel-value ranges of the restored image are adjusted according to the change state of the frequency coefficients converted by the coefficient conversion circuit 114. However, the adjustment circuit 116 may change the pixel-value ranges of the restored image in a more active manner. For example, in addition to the above-described adjustment process, the pixel-value ranges of the restored image may be multiplied by K, so as to adjust the pixel-value ranges more effectively. In this case, the ratio of coefficient conversion performed by the coefficient conversion circuit 114 may preferably be multiplied by 1/K. Thus, the processing effect on the restored image after the adjustment can be kept constant. According to the above-described method, since fluctuations in the pixel-value ranges of the restored image can be reduced by the multiplied coefficient-conversion rate, it becomes possible to keep a predetermined processing effect even though the adjustment circuit 116 changes the pixel-value ranges more actively than in usual cases.

As has been described, the dynamic range of the entire restored image can be kept the same as that of the entire original image by adjusting the pixel-value ranges of the restored image, so as to be the same as that of the original image. Further, it becomes possible to make the pixel-value ranges of the restored image agree with those of the original image by analyzing the pixel-value ranges of the restored image. Still further, since the frequency-component ratio can be changed, the following effects can be obtained. For example, it becomes possible to perform frequency processing suitable for the object. Further, it becomes possible to enhance the edges of a structure, such as a tumor, a bone, a blood vessel, and so forth, where the structure includes many low-frequency components. Thus, the visibility of the structure becomes higher than that of noise mainly including high-frequency components, whereby the diagnostic function of the image increases. Further, where the pixel-value ranges of the restored image are actively changed, a predetermined effect can be obtained.

Second Embodiment

According to a second embodiment of the present invention, the coefficient-conversion procedures performed by the coefficient conversion circuit 114 are different from those in the first embodiment. Since the other procedures performed in this embodiment are the same as those in the first embodiment, the description thereof is omitted. Therefore, only the coefficient-conversion procedures will be described.

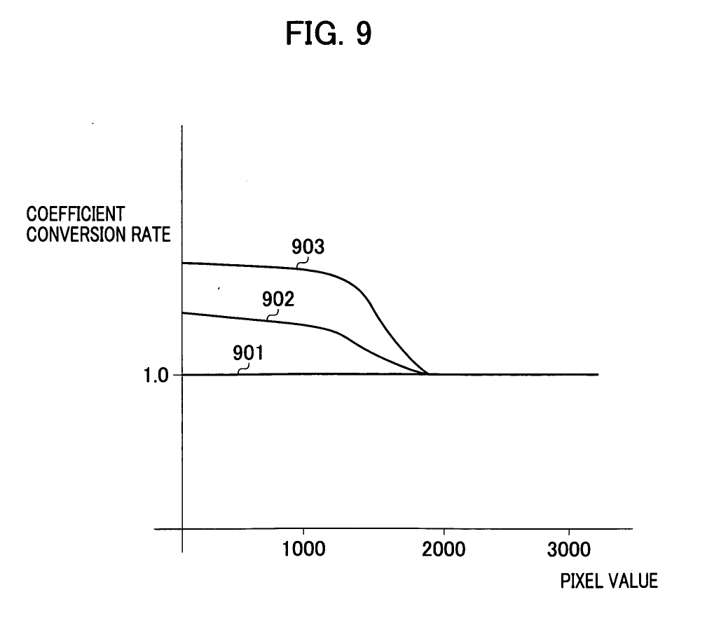

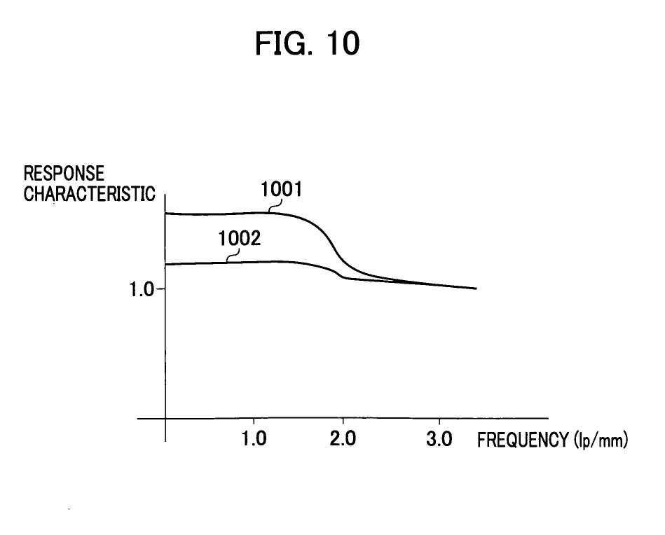

In FIG. 9, the horizontal axis indicates the pixel value of the original image and the vertical axis indicates the rate of conversion performed for each of coefficients on different levels. That is to say, the coefficients converted according to the coefficient conversion curves are further converted at this coefficient-conversion rate. For example, conversion rate 901 is used for a coefficient on a level of one, conversion rate 902 is used for a coefficient on a level of three, and conversion rate 903 is used for a coefficient on a level of five. These levels are selectively described, as typical examples, for the sake of description. Further, a predetermined level is selected from among these levels according to a selected body part. As the number of the level increases, a frequency component corresponding to the coefficient on this level becomes lower. For example, where the coefficient on the level of five is changed, the amplitude of a predetermined frequency is changed. This frequency is lower than that in the case where the coefficient on the level of one is changed. FIG. 10 illustrates an example response characteristic, where the horizontal axis indicates frequencies and the vertical axis indicates the response characteristic. Where the value of the response characteristic is one, for example, the amplitude of a frequency wave corresponding to the value is not changed. However, where the value of the response characteristic is one and five tenths, the amplitude of a frequency wave corresponding to the value increases by one and five tenths times.

In FIG. 10, reference numeral 1001 indicates a response characteristic on the low-pixel-value side of the original image and reference numeral 1002 indicates a response characteristic on the high-pixel-value side thereof. In this embodiment, the inclination value of the coefficient-conversion curve 502 (shown in FIG. 5 and described above with reference to the first embodiment) is determined to be one, so as to identify the effect of coefficient conversion.

The coefficient conversion circuit 114 performs frequency-coefficient conversion at the coefficient-conversion rates shown in FIG. 9, for example. Each frequency coefficient is calculated within a predetermined range corresponding thereto of the original image. Therefore, it becomes possible to calculate the coordinates of a pixel value of the original image by using the coordinates of this frequency coefficient. Thus, the pixel value corresponding to the frequency coefficient can be calculated. The coefficient-conversion rate can be determined according to the calculated pixel value. As the level of the coefficient conversion increases, the number of original images corresponding to one coefficient increases. That is to say, the number of pixels used for calculating one frequency coefficient increases. However, where a plurality of coordinates of pixel values of the original image corresponds to the coordinates of the frequency coefficient, a pixel value of coordinates at the center of the plurality of coordinates is determined to be a pixel value corresponding to the frequency coefficient. Thus, each frequency coefficient corresponds to a predetermined pixel value of the original image.

In FIG. 9, the frequency coefficient on the level of one is not changed, where this level corresponds to the highest frequency band. However, the rate of conversion performed for a frequency coefficient on the level of three increases, as the pixel value of the original image decreases, where the level of three corresponds to a frequency band lower than that corresponding to the level of one. Further, the rate of conversion performed for a frequency coefficient on the level of five increases, as the pixel value of the original image decreases, where the level of five corresponds to a frequency band lower than that corresponding to the level of three.

As a result, the response characteristic is changed so that the number of low-frequency components increases on the low-pixel value side of the original image, as shown in FIG. 10. Therefore, where the front of a chest is photographed, for example, the frequency processing is not performed for the lung area, which is a high-pixel value area. Further, where an abdomen or a mediastinum is photographed, the obtained image includes a low-pixel value area with increased graininess, the amplitude of low-frequency waves increases. In this case, however, the amplitude of high-frequency waves is not larger than that of the low-frequency waves. Therefore, the contrast of structures such as organs increases, even though frequency components corresponding to noise are not enhanced. That is to say, the contrast of the organs (significant information) increases and that of the noise (insignificant information) relatively decreases. Therefore, the contrast of the significant information of this image increases and that of the insignificant information relatively decreases. This image is referred to as an improved image. This improved image is easy to observe and suitable for making a diagnosis.

Although the horizontal axis indicates the pixel values in FIG. 9, it may indicate the amount of X-rays that reached the two-dimensional X-ray sensor 104. In this case, it becomes possible to understand the noise characteristic of the two-dimensional X-ray sensor 104 more directly than in the case where the horizontal axis indicates the pixel values. The amount of X-rays that reached the two-dimensional X-ray sensor 104 can be calculated directly from the output value of the two-dimensional X-ray sensor 104. For example, where the output value of the two-dimensional X-ray sensor 104 is linearly proportional to the X-ray reach amount, the output value can be determined to be the X-ray reach amount. Here, image improvement means increasing the contrast of the significant information (such as organs) in the image and decreasing the contrast of the insignificant information such as noise. That is to say, in an improved image, the contrast of the insignificant information is decreased, so as to be relatively lower than the contrast of the significant information.

As described above, in this embodiment, the frequency-component ratio can be changed according to the pixel value or the X-ray reach amount. The frequency-component ratio can also be changed according to the coefficient conversion lines.

Third Embodiment

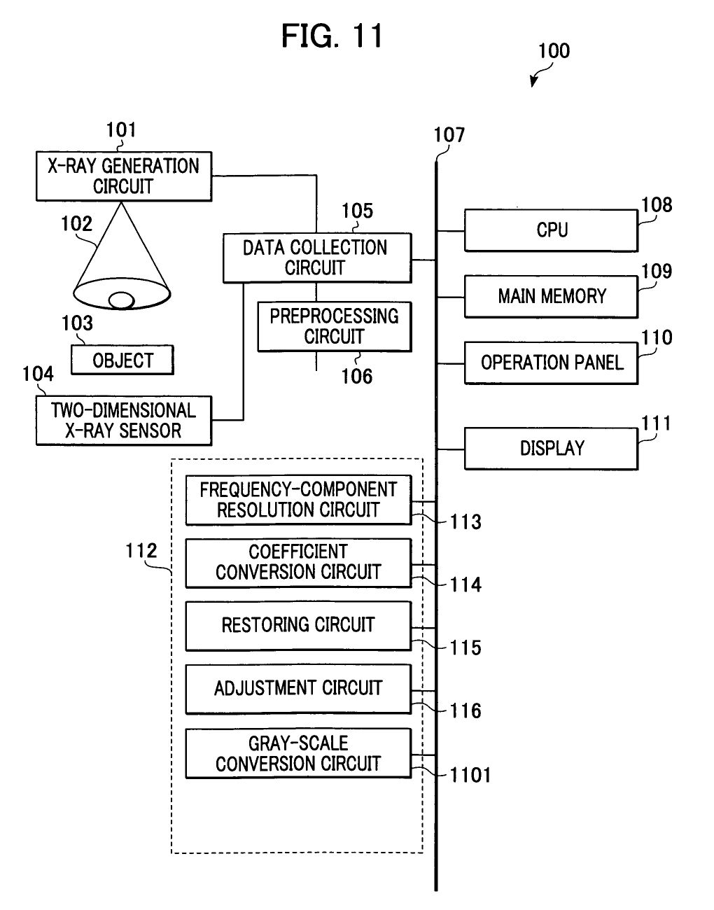

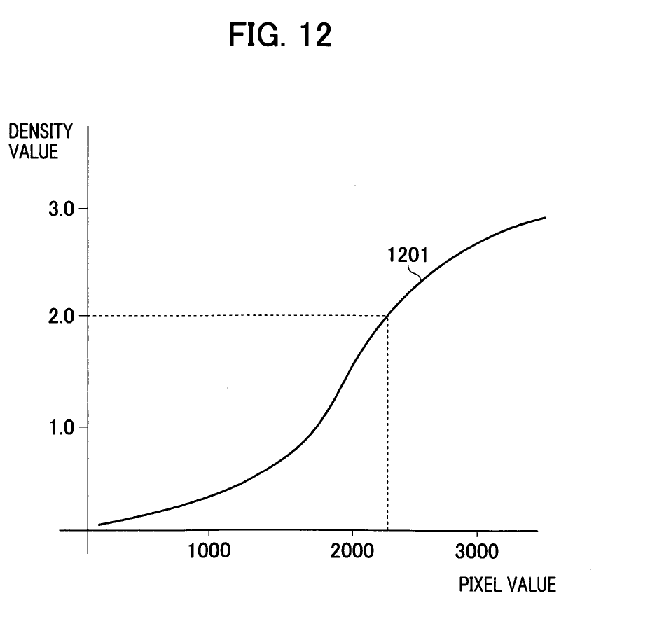

FIG. 11 illustrates an example configuration of a third embodiment of the present invention. The configuration of this embodiment is the same as those of the first and second embodiments except that a gray-scale conversion circuit 1101 is used and the procedures performed by the coefficient-conversion circuit 114 are different from those in the first and second embodiments. Therefore, the descriptions of processing procedures that are the same as those of the first and second embodiments are omitted and only coefficient conversion performed by the coefficient-conversion circuit 114 and the configuration of the gray-scale conversion circuit 1101 will be described. FIG. 12 shows a gray-scale conversion curve obtained by the gray-scale conversion circuit 1101. In FIG. 12, the horizontal axis indicates the pixel value and the vertical axis indicates the density value or brilliance value. A gray-scale process according to the gray-scale conversion curve is performed for an image restored by the restoring circuit 115 or an image whose ranges are adjusted by the adjustment circuit 116.

The vision of a person changes according to the density of a film and the brilliance on a monitor. Therefore, in this embodiment, the density value and brilliance value are used for the frequency processing. In the second embodiment, the coefficient conversion circuit 114 changes the frequency-coefficient conversion rate according to the pixel value. However, in the third embodiment, the coefficient conversion circuit 114 changes the frequency-coefficient conversion rate according to the density value or the brilliance value. More specifically, the relationship between the density value and the pixel value is obtained according to the gray-scale conversion curve shown in FIG. 12. Further, a frequency characteristic corresponding to the density value or the brilliance value is obtained according to the relationship shown in FIG. 8. That is to say, the density value is allotted for the pixel value and a response characteristic corresponding to the pixel value is adjusted.

Thus, in this embodiment, the frequency-component conversion rate can be changed according to the density value or the brilliance value, as described above. Therefore, the frequency processing can be performed according to a person's vision, which changes according to the density value or the brilliance value.

Fourth Embodiment

A fourth embodiment of the present invention relates to an image processing apparatus for changing the frequency-coefficient conversion rate according to the inclination of the gray-scale conversion curve and changing the frequency-component ratio according to an object to be photographed. The configuration of this embodiment is the same as that of the third embodiment, which is shown in FIG. 11, except the coefficient conversion performed by the coefficient conversion circuit 114. Therefore, the following description mainly relates to procedures performed by the coefficient conversion circuit 114.

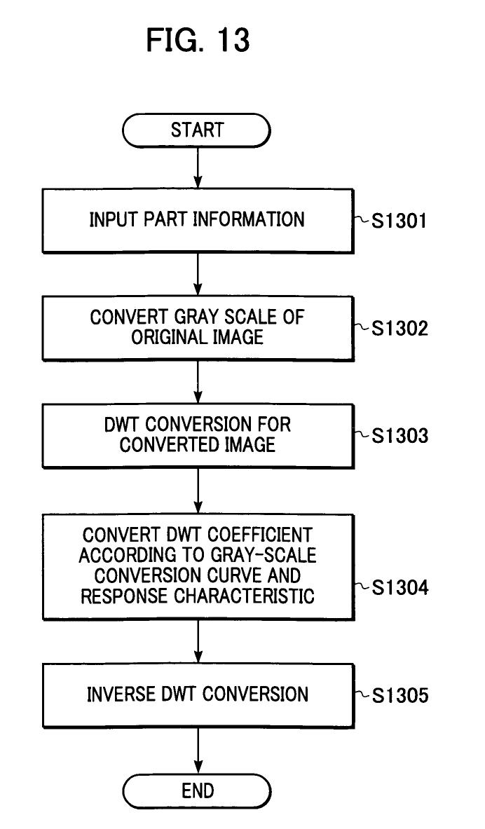

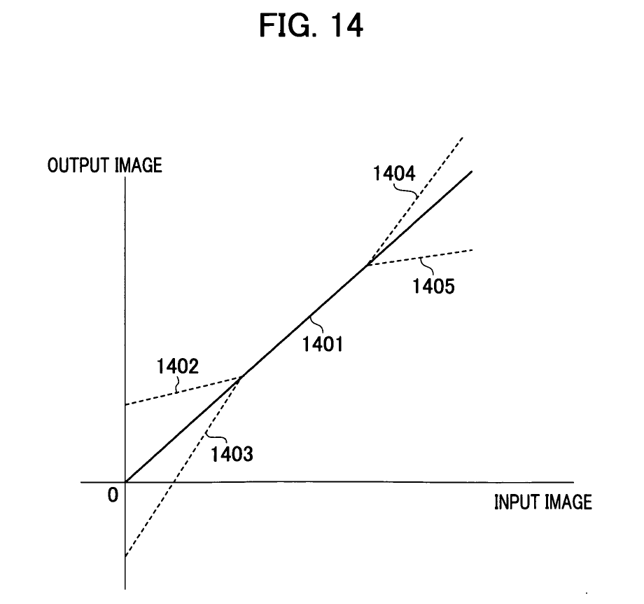

FIG. 13 is a flowchart illustrating the flow of processing procedures performed by the image processing circuit 112 and FIG. 14 illustrates an example gray-scale conversion curve f( ) used for changing the dynamic range of an image by the gray-scale conversion circuit 1101.

The configuration of this embodiment will now be described with reference to FIG. 13.

The original image subjected to the preprocessing through the preprocessing circuit 106 is transferred, as well as the part information, to the image-processing apparatus 112 via the CPU bus 107 at step S1301. In the image processing apparatus 112, first, the gray-scale conversion circuit 1101 converts an original image Org(x, y) into f(Org (x, y)) by using the gray-scale conversion curve f( ) at step S1302, where the x and y indicate coordinates on the original image. FIG. 14 shows an example gray-scale conversion curve f( ). The gray-scale conversion curve f( ) has a curve shape shown in FIG. 14, for example, where solid line 1401 indicates a function whose inclination value is one. In this case, since the input value and the output value are not changed, the effect of dynamic-range compression is not obtained. Broken line 1402 indicates a function obtained, where the dynamic range on the low-pixel value side is compressed, and broken line 1403 indicates a function obtained, where the dynamic range on the low-pixel value side is increased. Further, Broken line 1404 indicates a function obtained, where the dynamic range on the high-pixel value side is increased and broken line 1405 indicates a function obtained, where the dynamic range on the high-pixel value side is compressed. In this embodiment, each of these curves may preferably be a differential continuous curve. If not, a pseudo edge may be generated at a differential discontinuous point.

Next, the frequency-component resolution circuit (DWT conversion circuit) 113 performs the two-dimensional DWT conversion process for the image f(Org (x, y)) after the gray-scale conversion. Then, the frequency-component resolution circuit 113 calculates and outputs a frequency coefficient at step S1303. Thus, the DWT conversion process for image signals is performed.

At step S1304, the coefficient conversion circuit 114 converts a frequency coefficient hn (x, y) for each sub-band according to Equation (5) shown below:

h2n(x, y)=(1/f′(Org(x, y)))Xhn(x, y)Xαn(Org(x, y)) (5).

Here, the converted frequency coefficient is determined to be h2n(x, y), where n indicates the sub-band category, that is, the level. an (Org (x, y)) indicates a coefficient conversion rate on a level of n, which changes according to the value of the original image Org (x, y). Since the coefficient conversion rate αn( ) is determined according to the object, the frequency-component ratio can be determined according to the object. This determined value is used as an initial value.

Thus, the frequency-coefficient value of the image after being subjected to the gray-scale conversion process, which increased by f′(x, y) times relative to that of the original image, becomes almost the same as that of the original image. Here, the frequency coefficient of an LL sub-band corresponding to the lowest frequency component is not changed. In this case, frequency coefficients corresponding to high-frequency components are maintained to be almost the same as those of the original image, even though the dynamic range of the entire image is changed. The value of αn(Org(x, y)) is adjusted, so as to be one in an area where the inclination value of the gray-scale conversion curve f( ) is one and anything other than one in all other areas. In this case, the frequency-component ratio in the area with changed dynamic range can be adjusted at the same time. That is to say, the frequency-component ratio can be adjusted, as required, by changing the value of the coefficient conversion rate αn( ).

The restoring circuit 115 performs the inverse DWT conversion for the frequency coefficient converted by the coefficient conversion circuit 114 at step S1305.

Thus, according to this embodiment, the dynamic range of an image is changed and the frequency component ratio thereof is adjusted at the same time. Therefore, it becomes possible to change the dynamic range and perform frequency processing suitable for an object to be photographed. Since the gray-scale conversion process is performed before the frequency processing, the image is prevented from being affected by the pixel-value fluctuation due to the frequency processing. Thus, the dynamic range can be changed with high precision according to the pixel value of the original image.

Fifth Embodiment

A fifth embodiment relates to an image processing apparatus for changing the frequency-coefficient conversion rate according to the inclination of a gray-scale conversion curve and changing the frequency-component ratio. The configuration of this embodiment is the same as that of the third embodiment, which is shown in FIG. 11, except the coefficient conversion performed by the coefficient conversion circuit 114. Therefore, the following description mainly relates to processing procedures performed by the coefficient conversion circuit 114. The configuration of this embodiment is different from that of the fourth embodiment in that the frequency coefficient adjustment is performed before the gray-scale conversion process.

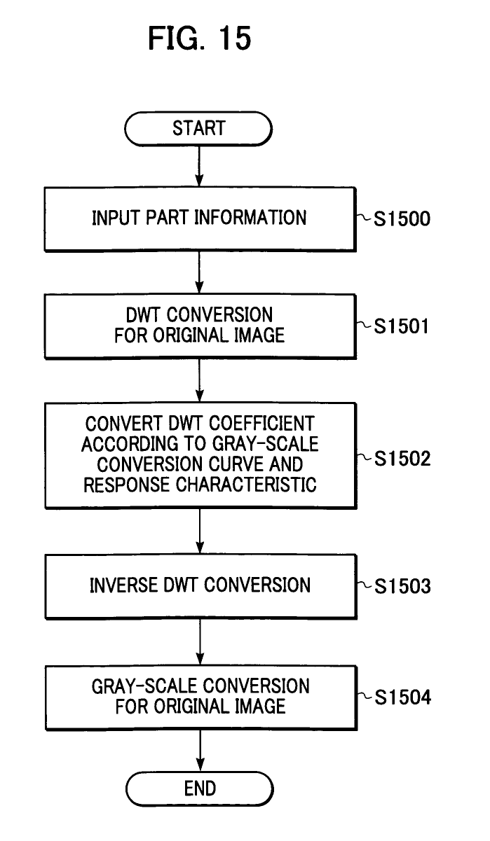

FIG. 15 is a flowchart illustrating the flow of processing procedures performed by the image processing circuit 112 and FIG. 14 illustrates the example gray-scale conversion curve f( ) used by the gray-scale conversion circuit 1101 for changing the dynamic range of an image.

The configuration of this embodiment will now be described in detail according to the flow of the processing procedures shown in FIG. 15.

The original image subjected to the preprocessing through the preprocessing circuit 106 is transferred, as well as the part information, to the image-processing apparatus 112 via the CPU bus 107 at step S1500. In the image processing apparatus 112, first, the frequency-component resolution circuit (DWT conversion circuit) 113 performs the two-dimensional DWT conversion process for the original image Org(x, y), calculates and outputs frequency coefficients (conversion coefficients) at step S1501, whereby the DWT conversion process is performed for the image signals of the original image. At step S1502, the coefficient conversion circuit 114 converts the frequency coefficient hn(x, y) for each sub-band according to Equation (6) shown below:

h2n(x, y)=(1/f′(Org(x, y)))Xhn(x, y)Xαn(Org(x, y)) (6).

Here, the converted frequency coefficient is determined to be h2n(x, y), where n indicates the sub-band category, that is, the level. an (Org (x, y)) indicates the coefficient conversion rate on the level of n, which changes according to the value of the original image Org (x, y). The coefficient conversion rate αn( ) is determined according to the adjusted frequency component. This determined value is used as an initial value. The coefficient conversion rate αn( ) can be determined according to the object.

Thus, the frequency-coefficient values are changed according to the frequency-coefficient values of the original image beforehand. Therefore, the frequency amplitude is prevented from being affected by the gray-scale conversion process that will be performed later.

Here, the frequency coefficient of the LL sub-band corresponding to the lowest frequency component is not changed. In this case, frequency coefficients corresponding to high-frequency components are maintained to be almost the same as those of the original image, even though the dynamic range of the entire image is changed by the gray-scale conversion process that is performed thereafter. The value of αn(Org(x, y)) is adjusted, so as to be one in an area where the inclination value of the gray-scale conversion curve f( ) is one and anything other than one in all other areas, whereby the frequency-component ratio in the area with changed dynamic range can be adjusted at the same time. That is to say, the frequency-component ratio can be adjusted, as required, and changed according to the object by changing the value of the coefficient conversion rate αn( ).

The restoring circuit 115 performs the inverse DWT conversion for the frequency coefficient converted by the coefficient conversion circuit 114 at step S1503. The gray-scale conversion circuit 1101 performs the gray-scale conversion process for the image restored by the restoring circuit 115 by using the gray-scale conversion curve f( ) at step S1504.

As described above, in this embodiment, the coefficient resolution for the original image is performed for adjusting the coefficients. Therefore, the coefficient resolution can be achieved without being affected by the gray-scale conversion process, whereby the precision of the coefficient adjustment increases. Further, the dynamic range of the image is changed and the frequency component ratio is adjusted at the same time. Therefore, it becomes possible to change the dynamic range and perform frequency processing suitable for the object.

As has been described, the present invention allows for adjusting the pixel-value range and the frequency-component ratio at the same time.

It is to be understood that a storage medium storing program code of software for implementing the functions of the apparatus or system may be supplied, according to the embodiments, to an apparatus or system so that a computer (CPU, micro-processor unit (MPU), etc.) of the apparatus or system reads and executes the program code stored in the storage medium.

In that case, the program code itself, read from the storage medium, achieves the functions of the embodiments.

The storage medium for providing the program code may be, for example, a read-only memory (ROM), a floppy disk, a hard disk, an optical disk, a magneto-optical disk, a Compact Disk Read-Only Memory (CD-ROM), a Compact Disk-Recordable (CD-R), a magnetic tape, a non-volatile memory card, etc.

Furthermore, not only by the computer reading and executing the program code, but also by an operating system (OS), etc. running on the computer based on instructions of the program code, part of or the entire process is executed, whereby the functions of any of the embodiments may be achieved.

The program code read from the storage medium may be written into a memory of a function extension board inserted in the computer or a function extension unit connected to the computer. The functions of the embodiments may be realized by executing part of or the entire process by a CPU, etc. of the function extension board or the function extension unit based on instructions of the program code.

When the present invention is applied to a program or a storage medium storing the program, it is to be understood that the program includes program code corresponding to the processing procedures shown in the flowcharts shown in FIGS. 2, 7, 13, and 15.

While the present invention has been described with reference to what are presently considered to be the preferred embodiments, it is to be understood that the invention is not limited to the disclosed embodiments. On the contrary, the invention is intended to cover various modifications and equivalent arrangements included within the spirit and scope of the appended claims. The scope of the following claims is to be accorded the broadest interpretation so as to encompass all such modifications and equivalent structures and functions.

What is claimed is:

1. An image processing apparatus comprising:
a frequency-component resolution unit that converts an original image into frequency coefficients, each of the frequency coefficients corresponding to a predetermined one of a plurality of frequency bands;
a frequency-component conversion unit that is in communication with the frequency-component resolution unit and converts the frequency coefficients into converted frequency coefficients by using frequency-coefficient conversion curves, each of the frequency-coefficient conversion curves corresponding to a predetermined one of the plurality of frequency bands;
a restoring unit that is in communication with the frequency-component conversion unit and composes a processed image from the converted frequency coefficients; and
an adjustment unit that is in communication with the restoring unit and adjusts a pixel-value range of the processed image, the pixel-value range having a predetermined value.

2. An image processing apparatus according to claim 1, wherein the adjustment unit adjusts the pixel-value range of the processed image based on a pixel-value range of the original image.

3. An image processing apparatus according to claim 1, wherein the frequency-component conversion unit changes a conversion rate of the frequency coefficients based on a change rate of the pixel-value range adjusted by the adjustment unit.

4. An image processing apparatus according to claim 1, wherein the frequency-component conversion unit converts the frequency coefficients according to pixel values of the original image, each of the pixel values corresponding to a predetermined one of the frequency coefficients and a predetermined one of the frequency-coefficient conversion curves.

5. An image processing apparatus according to claim 1, wherein the frequency-component conversion unit converts the frequency coefficients with reference to an object to be photographed according to the frequency-coefficient conversion curves.

6. An image processing apparatus according to claim 1, wherein the frequency-component conversion unit converts the frequency coefficients according to density values, each of the density values corresponding to a predetermined one of the frequency coefficients, and a predetermined one of the frequency-coefficient conversion curves.

7. An image processing apparatus according to claim 1, wherein the frequency-component resolution unit converts the original image into frequency coefficients using wavelet conversion.

8. An image processing apparatus according to claim 1, wherein the frequency-component resolution unit converts the original image into frequency coefficients using Laplacian conversion.

9. An image processing apparatus according to claim 1, further comprising:
an X-ray emission unit that emits an X-ray;
a two-dimensional X-ray sensor that is in communication with the X-ray emission unit and converts the X-ray into image data; and
an image generator that is in communication with the two-dimensional X-ray sensor and generates the original image based on the image data.

10. An image processing apparatus comprising:
a gray-scale conversion unit that converts an original image into a converted image by using gray-scale conversion curves;
a frequency-component resolution unit that is in communication with the gray-scale conversion unit and converts the converted image into frequency coefficients, each of the frequency coefficients corresponding to a predetermined one of a plurality of frequency bands;
a frequency-component conversion unit that is in communication with the frequency-component resolution unit and generates changed frequency coefficients by changing the frequency coefficients based on inclinations of the gray-scale conversion curves, and converts the changed frequency coefficients into converted frequency coefficients by using frequency-coefficient conversion curves, each of the frequency-coefficient conversion curves corresponding to a predetermined one of the plurality of frequency bands; and
a restoring unit that is in communication with the frequency-component conversion unit and composes a processed image from the converted frequency coefficients.

11. An image processing apparatus according to claim 10, wherein the frequency-component conversion unit converts the changed frequency coefficients with reference to an object to be photographed according to the frequency-coefficient conversion curves.

12. An image processing apparatus comprising:
a frequency-component resolution unit that converts an original image into frequency coefficients, each of the frequency coefficients corresponding to a predetermined one of a plurality of frequency bands;
a frequency-component conversion unit that is in communication with the frequency-component resolution unit and generates changed frequency coefficients by changing the frequency coefficients based on inclinations of the gray-scale conversion curves, and converts the changed frequency coefficients into converted frequency coefficients by using frequency-coefficient conversion curves, each of the frequency-coefficient conversion curves corresponding to a predetermined one of the plurality of frequency bands;
a restoring unit that is in communication with the frequency-component conversion unit and composes a processed image from the converted frequency coefficients; and
a gray-scale conversion unit that is in communication with the restoring unit and converts the processed image into a converted image by using gray-scale conversion curves.

13. An image processing apparatus according to claim 12, wherein the frequency-component conversion unit converts the changed frequency coefficients with reference to an object to be photographed according to the frequency-coefficient conversion curves.

14. An image processing method comprising:
converting an original image into frequency coefficients, each of the frequency coefficients corresponding to a predetermined one of a plurality of frequency bands;
converting the frequency coefficients into converted frequency coefficients by using frequency-coefficient conversion curves, each of the frequency-coefficient conversion curves corresponding to a predetermined one of the plurality of frequency bands;
composing a processed image from the converted frequency coefficients; and
adjusting a pixel-value range of the processed image, the pixel-value range having a predetermined value.

15. An image processing method according to claim 14, wherein the pixel-value range of the processed image is adjusted based on a pixel-value range of the original image.

16. An image processing method according to claim 14, wherein a conversion rate of the frequency coefficients used for converting the frequency coefficients is changed based on a change rate of the pixel-value range that is adjusted.

17. An image processing method comprising:
converting an original image into a converted image by using gray-scale conversion curves;
converting the converted image into frequency coefficients, each of the frequency coefficients corresponding to a predetermined one of a plurality of frequency bands;
generating changed frequency coefficients by changing the frequency coefficients based on inclinations of the gray-scale conversion curves;
converting the changed frequency coefficients into converted frequency coefficients by using frequency-coefficient conversion curves, each of the frequency-coefficient conversion curves corresponding to a predetermined one of the plurality of frequency bands; and
composing a processed image from the converted frequency coefficients.

18. An image processing method comprising:
converting an original image into frequency coefficients, each of the frequency coefficients corresponding to a predetermined one of a plurality of frequency bands;
generating changed frequency coefficients by changing the frequency coefficients based on inclinations of the gray-scale conversion curves;
converting the changed frequency coefficients into converted frequency coefficients by using frequency-coefficient conversion curves, each of the frequency-coefficient conversion curves corresponding to a predetermined one of the plurality of frequency bands;
composing a processed image from the converted frequency coefficients; and
converting the processed image into a converted image by using gray-scale conversion curves.

19. A storage medium including, stored therein, program code for making a computer perform an image processing method, the image processing method comprising:
converting an original image into frequency coefficients, each of the frequency coefficients corresponding to a predetermined one of a plurality of frequency bands;
converting the frequency coefficients into converted frequency coefficients by using frequency-coefficient conversion curves, each of the frequency-coefficient conversion curves corresponding to a predetermined one of the plurality of frequency bands;
composing a processed image from the converted frequency coefficients; and
adjusting a pixel-value range of the processed image, the pixel-value range having a predetermined value.

20. A storage medium according to claim 19, wherein the pixel-value range of the processed image is adjusted based on a pixel-value range of the original image.
